(19) United States
(12) Patent Application Publication
(10) Pub. No.: US 2024/0329998 A1
(43) Pub. Date: Oct. 3, 2024

(54) WAVE LEVEL MATRIX MULTIPLY INSTRUCTIONS

(71) Applicant: Advanced Micro Devices, Inc., Santa Clara, CA (US)

(72) Inventors: Bin He, Oviedo, FL (US); Michael J. Mantor, Orlando, FL (US); Brian D. Emberling, Palo Alto, CA (US)

(21) Appl. No.: 18/619,392

(22) Filed: Mar. 28, 2024

Related U.S. Application Data
(60) Provisional application No. 63/493,972, filed on Apr. 3, 2023.

(51) Int. Cl. G06F 9/38; G06F 9/30

(52) U.S. Cl. CPC G06F 9/3802; G06F 9/3001; G06F 9/30098; G06F 9/3867

(57) ABSTRACT

An apparatus and method for efficiently processing multiplication and accumulate operations for matrices in applications. In various implementations, a computing system includes a parallel data processing circuit and a memory. The memory stores the instructions (or translated commands) of a parallel data application. The circuitry of the parallel data processing circuit performs a matrix multiplication operation using source operands accessed only once from a vector register file and multiple instantiations of a vector processing circuit capable of performing multiple matrix multiplication operations corresponding to multiple different types of instructions. The multiplier circuit and the adder circuit of the vector processing circuit perform each of the fused multiply add (FMA) operation and the dot product (inner product) operation without independent, dedicated execution pipelines with one execution pipeline for the FMA operation and the other separate execution pipeline for the dot product operation.

### CROSS REFERENCE TO RELATED APPLICATIONS

This application claims priority to Provisional Patent Application Ser. No. 63/493,972, entitled “WAVE LEVEL MATRIX MULTIPLY INSTRUCTIONS”, filed Apr. 3, 2023, the entirety of which is incorporated herein by reference.

### BACKGROUND

### Description of the Relevant Art

Multilayer networks are used in a variety of applications in a variety of fields such as physics, chemistry, biology, engineering, social media, finance, and so on. Some of the applications that use multilayer networks are text recognition, image recognition, speech recognition, and recommendation systems. Multilayer networks classify data to provide an output value representing a prediction when given a set of inputs. The multilayer network uses multiple hidden layers of nodes (or neurons) between an input layer and an output layer of nodes. Each node has a specified activation function and a specified weight that is determined during training of the multilayer network. The nodes of the hidden layers, other than the last hidden layer, are not directly connected to the output layer.

Many different types of computing systems that support execution of multilayer networks include vector processing circuits or single-instruction, multiple-data (SIMD) processors. SIMD circuits include multiple parallel lanes of execution. Tasks can be executed in parallel on these types of parallel processing circuits to increase the throughput of the computing system. Various types of machine learning algorithms are being implemented on these types of processors, often in graphical processing units (GPUs). Some of these machine learning algorithms use operations that include a fused multiply add (FMA) operation and a dot product (inner product) operation. Each of these operations include a matrix multiplication operation followed by an addition operation.

Matrix multiplication operations typically take many clock cycles to generate results while consuming a large amount of power. In addition, the matrix multiplication operations perform multiple fetch operations from a vector register file to retrieve operands. Each of the FMA operation and the dot product operation are repeatedly used in many machine learning algorithms. In addition to the matrix multiplication operations, these operations also include addition operations that fetch from the vector register file and consume power. When operations that are repeatedly performed in an application are not efficient, data storage of the source code increases, power consumption increases, and throughput of the application declines. If an organization cannot support the cost of using machine learning data models, then the organization is unable to benefit from the machine learning data models.

In view of the above, efficient methods and apparatuses for efficiently processing multiplication and accumulate operations for matrices in applications are desired.

### BRIEF DESCRIPTION OF THE DRAWINGS

FIG. 1 is a generalized diagram of a matrix multiplier that efficiently processes multiplication and accumulate operations for matrices in applications.

FIG. 2 is a generalized diagram of a matrix multiplier that efficiently processes multiplication and accumulate operations for matrices in applications.

FIG. 3 is a generalized diagram of a compute circuit that efficiently processes multiplication and accumulate operations for matrices in applications.

FIG. 4 is a generalized diagram of a method for efficiently processing multiplication and accumulate operations for matrices in applications.

FIG. 5 is a generalized diagram of an apparatus that efficiently processes multiplication and accumulate operations for matrices in applications.

FIG. 6 is a generalized diagram of a computing system that efficiently processes multiplication and accumulate operations for matrices in applications.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for efficiently processing multiplication and accumulate operations for matrices in applications are contemplated. In various implementations, a computing system includes a parallel data processing circuit and a memory. The parallel data processing circuit uses a parallel data microarchitecture such as a single instruction multiple data (SIMD) parallel microarchitecture. The memory stores at least the instructions (or translated commands) of a parallel data application. The circuitry of the parallel data processing circuit performs a matrix multiplication operation using source operands accessed only once from a vector register file. Data storage elements used as temporary storage in the parallel processing circuit provide data reuse between iterations of computations performed to provide the matrix multiplication operation. In addition, the parallel data processing circuit utilizes multiple instances of a given vector arithmetic logic unit (ALU) capable of performing multiple matrix multiplication operations corresponding to multiple different types of instructions. The data reuse between threads performing the matrix multiplication operation reduces both the data movement within the parallel data processing circuit and the power consumption of the parallel data processing circuit. In addition, the vector register file is made more available for other operations, which reduces latency and increases performance. The circuitry reuse of the given vector ALU reduces on-die area of the parallel data processing circuit.

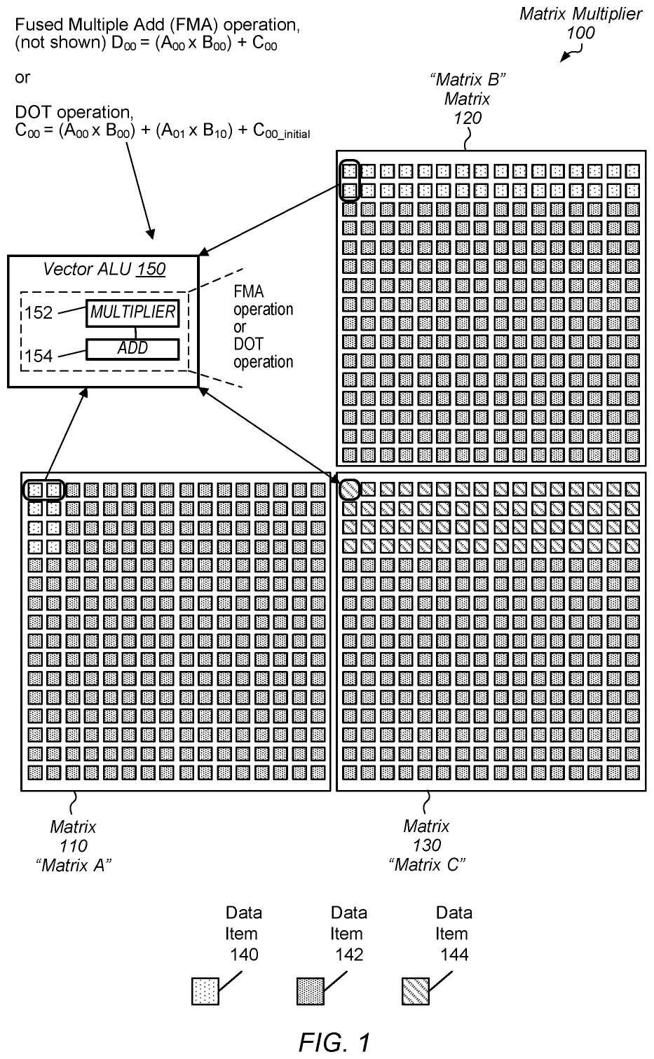

In various implementations, each of the vector ALUs includes a multiplier circuit and an adder circuit. In various implementations, the multiplier circuit and the adder circuit are used to provide the functionality of at least each of the fused multiply add (FMA) operation and the dot product (inner product) operation. In such implementations, each of the vector ALUs does not include two independent, dedicated execution pipelines with one execution pipeline for the FMA operation and the other separate execution pipeline for the dot product operation. Rather, each of the vector ALUs includes a single execution pipeline for each of the FMA operation and the dot product operation. In various implementations, each of the vector ALUs includes multiple multiplier circuits, each having a size less than the size of data items read from the vector register file. The multiple vector ALUs support execution of a single Wave Matrix Multiply Accumulate (WMMA) instruction that performs a multiplication and accumulate operation for matrices. Further details of these techniques to efficiently process multiplication and accumulate operations for matrices in applications are provided in the following description of FIGS. 1-6.

Turning now to FIG. 1, a generalized block diagram of matrix multiplier 100 is shown. In various implementations, matrix multiplier 100 includes circuitry of vector arithmetic logic unit (ALU) 150, which includes a multiplier circuit 152 and an adder circuit 154. Although not shown, vector ALU 150 can include a variety of other types of execution circuits such as a comparator circuit, a norm functional circuit, a rounding functional circuit, a clamping circuit, a divider circuit, a square root function circuit, and so forth. Vector ALU 150 can also include circuitry that supports a variety of mathematical operations such as integer mathematical operations, Boolean bit-wise operations, and floating-point mathematical operations. Vector ALU 150 can also include a vector register file (not shown) for storing operand data for vector operations. The operand data stored in the vector register file includes data elements of matrix 110, matrix 120 and matrix 130. Matrix 110 can also be referred to as matrix A, matrix 120 can also be referred to as matrix B, and matrix 130 can also be referred to as matrix C.

In various implementations, matrix multiplier 100 is included in one of multiple instantiations of execution lanes. Each lane is also referred to as a single instruction multiple data (SIMD) lane. In some implementations, the multiple instantiations of execution lanes are used in a parallel data processing circuit such as a graphics processing unit (GPU), a digital signal processor (DSP), a field programmable gate array (FPGA), or otherwise. Parallel data processing circuits are efficient for data parallel computing found within loops of applications, such as in applications for computer and mobile device display graphics, molecular dynamics simulations, deep learning training, finance computations, and so forth.

In one implementation, each of the matrices 110, 120 and 130 is a 16×16 matrix with 256 data elements (16×16=256) arranged in 16 rows and 16 columns. In an implementation, the data elements of each entry in matrices 110, 120 and 130 are a 16-bit floating point value, but in other implementations, the data elements can be represented in other data formats and/or with other numbers of bits. Each of the data elements of the entries of the matrices 110, 102 and 130 is one of a data item 140, data item 142 and data item 144. The data items 140, 142 and 144 represent different data associated with a different thread assigned on different SIMD lanes of the multiple SIMD lanes. A particular combination of the same instruction and a particular data item of the data items of matrices 110, 120 and 130 is referred to as a “work item.” Data items 142 are data items that have been retrieved from the vector register file. In some implementations, data items 142 are retrieved from the vector register file and stored in temporary storage elements such as flip-flop circuits, registers, random-access memory, or other. Therefore, the data of the rows and columns of matrices 110 and 120 are retrieved only once from the vector register file. The data are shared and reused between iterations of computations performed to provide the matrix multiplication operation.

Data items 140 are data items that have been retrieved from the vector register file and sent to vector ALU 150 that performs one of a fused multiply add (FMA) operation and a dot product (inner product) operation. Each of these operations include a matrix multiplication operation followed by an addition operation. Vector ALU 150 uses the multiplier circuit 152 and the adder circuit 154 to perform the FMA operation and the dot product operation. Therefore, vector ALU 150 does not include two independent, dedicated execution pipelines with one execution pipeline for the FMA operation and the other separate execution pipeline for the dot product operation. Rather, vector ALU 150 includes a single execution pipeline for each of the FMA operation and the dot product operation that uses data items 140 in a particular clock cycle. Vector ALU 150 generates data items 144 that overwrite the data items 142 of matrix 130.

In some implementations, matrix 110 is a portion of a first matrix and matrix 120 is a portion of a second matrix. The first and second matrices can be partitioned into smaller matrices, with matrix operations being performed on the smaller matrices by vector ALU 150. In various implementations, the multiplier circuit 152 and the adder circuit 154 are used to implement each of a fused multiply add (FMA) operation and a dot product (inner product) operation. Therefore, vector ALU 150 does not include two independent, dedicated execution pipelines with one execution pipeline for the FMA operation and the other separate execution pipeline for the dot product operation. Rather, vector ALU 150 includes a single execution pipeline for each of the FMA operation and the dot product operation. In various implementations, multiplier circuit 152 includes multiple multiplier circuits, each having a size less than the size of operands received by the multiplier circuit 152. As described earlier, the operands can be data elements of matrix 110 and matrix 120.

In an implementation, multiplier circuit 152 receives operands, such as data items 140, with a size of N bits where N is a positive non-zero integer. In this implementation, multiplier circuit 152 includes four multiplier circuits, each with a size of N/2 bits. A first multiplier circuit of multiplier circuit 152 multiplies the most-significant N/2 bits of the N-bit multiplicand operand and the most-significant N/2 bits of the N-bit multiplier operand. A second multiplier circuit of multiplier circuit 152 multiplies the least-significant N/2 bits of the N-bit multiplicand operand and the most-significant N/2 bits of the N-bit multiplier operand. A third multiplier circuit multiplies the most-significant N/2 bits of the N-bit multiplicand operand and the least-significant N/2 bits of the N-bit multiplier operand. A fourth multiplier circuit multiplies the least-significant N/2 bits of the N-bit multiplicand operand and the least-significant N/2 bits of the N-bit multiplier operand.

With an N-bit multiplicand operand “A,” the most-significant N/2 bits are represented by A_{H} and the least-significant N/2 bits are represented by A_{L}. A data item 140 of matrix 110 can be the N-bit multiplicand operand “A.” With an N-bit multiplier operand “B,” the most-significant N/2 bits are represented by B_{H} and the least-significant N/2 bits are represented by B_{L}. A data item 140 of matrix 120 can be the N-bit multiplicand operand “B.” Using the first multiplier circuit, the second multiplier circuit, the third multiplier circuit, and the fourth multiplier circuit of multiplier circuit 152, the N×N larger multiplier circuit 152 can be implemented using the below equation:

$$A \times B = ( {2}^{( 2 N )} \times {A}_{H} \times {B}_{H} ) + ( {2}^{N} \times {A}_{H} \times {B}_{L} ) + ( {2}^{N} \times {A}_{L} \times {B}_{H} ) + ( {A}_{L} \times {B}_{L} )$$

The partial products from the four N/2 bit multiplier circuits are arranged and summed by adder circuits. These adder circuits are separate adder circuits used by adder circuit 154. In the above implementation, multiplier circuit 152 uses four (N/2)× (N/2) multiplier circuits to provide a result (product) that can be generated by a single N×N multiplier circuit. In some implementations, vector ALU 150 performs 32-bit arithmetic operations. Therefore, the multiplier circuit 152 provides the result (product) of a multiplication operation that receives two data items 140 that are two 32-bit source operands. Adder circuit 154 adds the result (product) to a third 32-bit operand of the FMA operation. For example, the FMA operation generates a result for (A× B)+C, where each of the operands A, B and C is an N-bit operand or one of the data items 140 of matrices 110, 120 and 130. Adder circuit 154 performs the addition operation using the product (A× B) and the operand C as the two operands for the addition operation.

When the data items 142 of matrix 110 and matrix 120 use a floating-point format, each of the data items 142 includes a corresponding mantissa and a corresponding exponent. A sum of the number of bits of the mantissa and the number of bits of the exponent equals the total data size of a particular operand represented in the floating-point format. The precision of the floating-point number is equal to the size of the mantissa. Typically, a 32-bit floating-point data format includes the significand, which is also referred to as the mantissa, with a size of 23 bits and an exponent with a size of 8 bits. The 32-bit floating-point data format typically includes an implicit bit, which increases the size of the significand to 24 bits. Therefore, the typical 32-bit floating-point value has a precision of 24 bits. In an implementation, each of the data items 140-144 of matrices 110, 120 and 130 is a data value in the precision of the 32-bit IEEE-754 single-precision floating-point data format. In such an implementation, rather than using a single 24-bit multiplier circuit within multiplier circuit 152, multiplier circuit 152 uses four 12-bit multiplier circuits to provide the result (product) based on the above equation (e.g., A× B).

In various implementations, the four (N/2)-bit multiplier circuits of multiplier circuit 152 are reused for a separate dot product (inner product) operation. The dot product operation generates a result for (A× B)+ (C× D)+E, where each of the operands A, B, C, D and E is an N-bit operand from the matrices 110, 120 and 130. Two of the four (N/2)-bit multiplier circuits of multiplier circuit 152 generate the partial product (A× B) and another two of the four (N/2)-bit multiplier circuits of multiplier circuit 152 generate the partial product (C× D). Adder circuit 154 performs the addition operation using the product (A× B), the product (C× D) and the operand E as the three operands for the addition operation.

In some implementations, the multiplier circuit 152 supports a 16-bit floating-point data format for the dot product operation. Typically, a 16-bit floating-point data format includes the significand (mantissa) with a size of 10 bits and an exponent with a size of 5 bits. The 16-bit floating-point data format typically includes an implicit bit, which increases the size of the significand to 11 bits. Therefore, the typical 16-bit floating-point value has a precision of 11 bits. In some implementations, multiplier circuit 152 uses four 12-bit multiplier circuits. These four 12-bit multiplier circuits are used to perform a 24-bit multiplication for the FMA operation, and these four 12-bit multiplier circuits are reused to generate the partial products (A×B) and (C×D) for the dot product operation. Therefore, vector ALU 150 does not include two independent, dedicated execution pipelines with one execution pipeline for the FMA operation and the other separate execution pipeline for the dot product operation. Using data operands from the matrices 110, 120 and 130, in an implementation, vector ALU 150 performs the FMA operation to generate a result for D₀₀=(A₀₀× B₀₀)+C₀₀ and vector ALU 150 can be reused for performing the dot product operation to generate a result for C₀₀=(A₀₀× B₀₀)+ (A₀₁× B₁₀)+C₀₀_initial.

In an implementation, in a single clock cycle (or single pipeline stage), vector ALU 150 performs the dot product operation to generate the result for C₀₀ of matrix 130. The dot product operation includes four operations with two matrix multiplications to generate the partial products and two additions to sum the partial products and the initial value of the data item for C₀₀ of matrix 130. When a parallel data processing circuit includes 64 instantiations of vector ALU 150, in the single clock cycle (or single pipeline stage), the parallel data processing circuit generates 64 data items 144 of matrix 130 (e.g., C₀₀ to C_{0.15}, C₁₀ to C_{1.15}, C₂₀ to C_{2.15}, and C₃₀ to C_{3.15}). In the single clock cycle, the parallel data processing circuit with 64 instantiations of vector ALU 150, performs 256 operations (4 operations per dot product operation x 64 instantiations of vector ALU 150). In 32 clock cycles, (32 pipeline stages), the parallel data processing circuit uses the 64 instantiations of vector ALU 150 to generate the final data items of matrix 130 using 2,048 operations (256 operations per clock cycle x 32 clock cycles). During the 32 clock cycles and the 2,048 operations, the parallel data processing circuit with 64 instantiations of vector ALU 150 fetches the data items of matrices 110, 120 and 130 only once and stores initial and intermediate results in temporary storage elements.

In an implementation, vector ALU 150 performs different types of dot product operations such as the Dot2 product operation, the Dot4 product operation, and so forth. In some implementations, the vector ALU 150 performs the FMA operation and the dot product operation using one of multiple data formats such as the 32-bit floating-point data format, the 16-bit bfloat16 data format, the 8-bit fixed-point int8 integer data format, the 4-bit fixed-point int4 integer data format, one of a variety of types of directional blocked data formats, one of a variety of types of scalar data formats, and so forth. These data formats provide a variety of precisions.

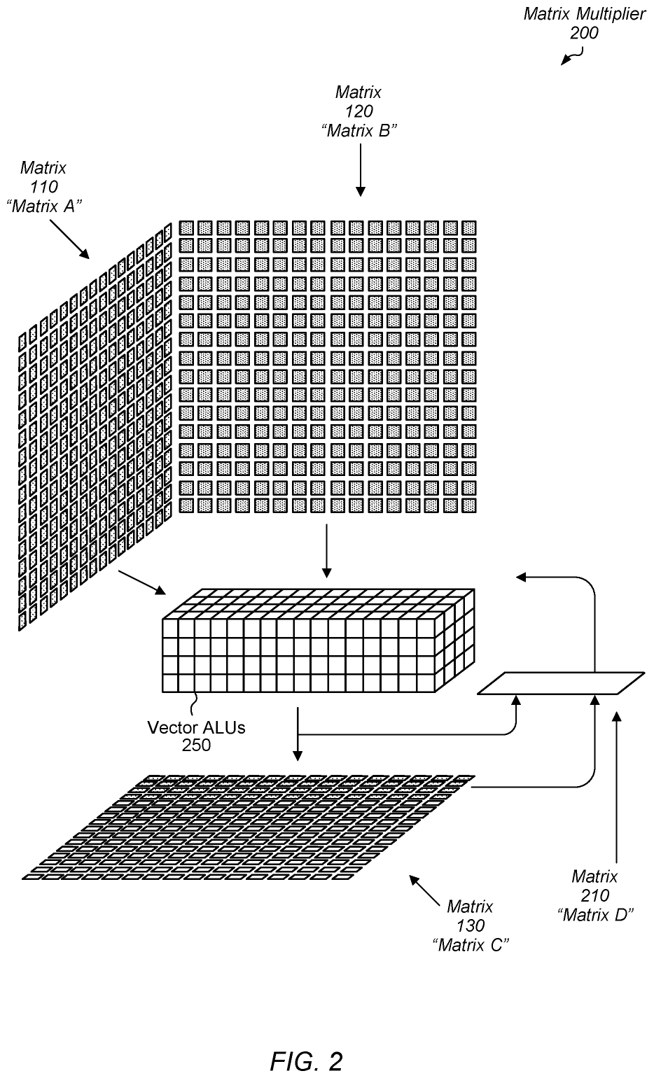

Referring to FIG. 2, a generalized block diagram of matrix multiplier 200 is shown. Circuitry, data elements and components previously described are numbered identically. In various implementations, each vector ALU of the multiple vector ALUs 250 includes the circuitry and functionality of vector ALU 150 (of FIG. 1). Therefore, each of the vector ALUs of vector ALUs 250 uses a multiplier circuit and an adder circuit 154 to perform the FMA operation and the dot product operation. Each of the vector ALUs 250 does not include two independent, dedicated execution pipelines or two separate circuit blocks, each with a multiplier circuit and an adder circuit, to perform the FMA operation and the dot product operation. Each of the vector ALUs 250 reuse circuitry to perform the FMA operation and the dot product operation. Using data elements from matrices 110, 120 and 130, vector ALUs 250 generate results in matrix 210, which is also referred to as “Matrix D.” Matrix 210 can be intermediate results that are bypassed into vector ALUs 250 to generate next intermediate results. Matrix D can also be the final results stored in the vector register file (not shown). Vector ALUs 250 can represent multiple instantiated vector ALUs with each instantiated vector ALU being used in a respective SIMD lane of multiple SIMD lanes of a parallel data processing circuit. Examples of the parallel data processing circuit are a graphics processing unit (GPU), a digital signal processor (DSP), a field programmable gate array (FPGA), or otherwise.

In some implementations, data items are retrieved from the vector register file and stored in temporary storage elements (not shown) such as flip-flop circuits, registers, random-access memory, or other. Therefore, the rows and columns of matrices 110, 120 and 130 are retrieved only once from the vector register file. Data items of matrix 210 can also be stored in the temporary storage elements to be later used by subsequent operations. As described earlier, in an implementation, each of the matrices 110, 120 and 130 is a 16×16 matrix with 256 data items (16×16=256) arranged in 16 rows and 16 columns.

In some implementations, multiple instantiations of the vector ALU 150 (of FIG. 1) and the multiple vector ALUs 250 can be used to execute a single Wave Matrix Multiply Accumulate (WMMA) instruction that performs a multiplication and accumulate operation for matrices 110 and 120, which replaces multiple instructions being used to perform the multiplication and accumulate operation for the entire sizes of the matrices 110 and 120. Therefore, a designer or software developer does not need to include a first set of multiple instructions in a parallel data application to fetch data items of portions of the matrices 110 and 120, a second set of multiple instructions to perform the matrix multiplication operations of the portions of the matrices 110 and 120, a third set of multiple instructions to perform the accumulate operations for the portions of the matrices 110 and 120, and include a loop to repeat the operations of the first set, the second set and the third set of multiple instructions. The single WMMA instruction includes indications specifying a data size of the matrices 110 and 120, a data format of data items of the matrices 110 and 120, addresses pointing to storage locations storing the matrices 110 and 120, and a destination address pointing to a storage location for storing the resulting matrix of the single WMMA instruction.

In various implementations, the vector ALU 150 (of FIG. 1) and the multiple vector ALUs 250 can be used to execute a Generalized Matrix Multiplication (GEMM) operation. The GEMM operation uses the below equation:

$$D = ( scalar value 1 ) \times ( A \times B ) + ( scalar value 2 ) \times C$$

A scalar register file can store each of the (scalar value 1) data item and the (scalar value 2) data item. The vector ALU 150 (of FIG. 1) and the multiple vector ALUs 250 can reuse the circuitry that perform either of the FMA operation or the dot product operation in a particular clock cycle or pipeline stage. The GEMM operations are used to perform Fast-Fourier Transforms for signal processing, physics and fluid dynamics simulations, executing machine learning operations and so forth. The single WMMA instruction optimizes the multiple operations performed for these applications.

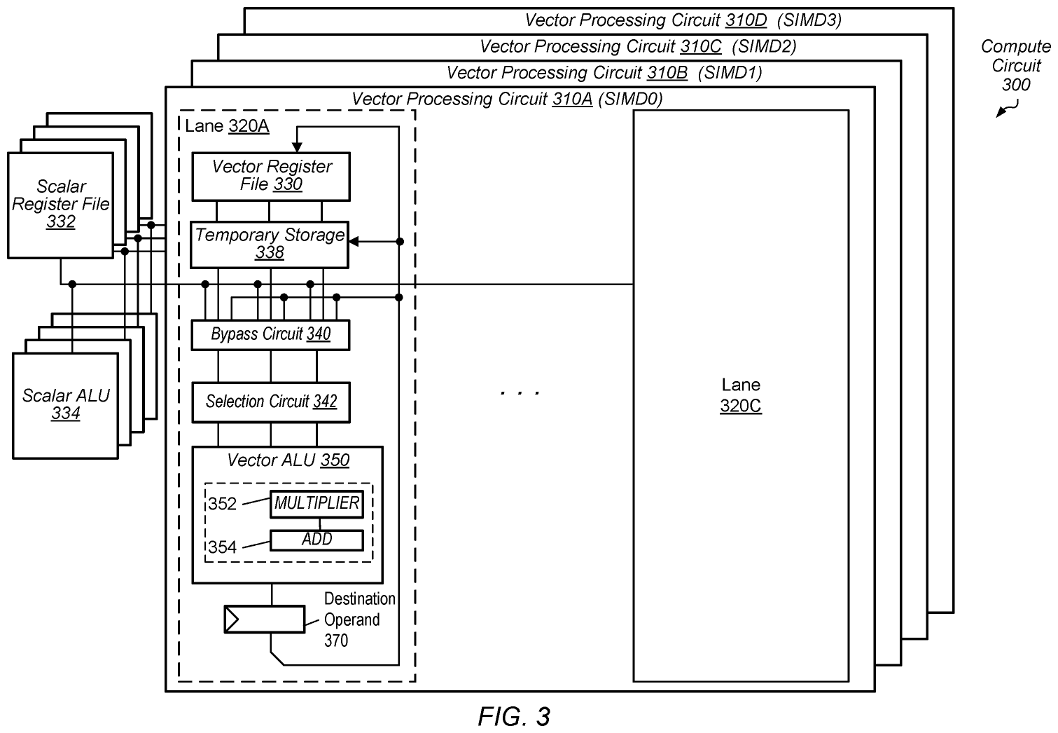

Turning now to FIG. 3, a generalized block diagram of compute circuit 300 is shown. In the illustrated implementation, compute circuit 300 includes the multiple vector processing circuits 310A-310D, each with multiple lanes 320A-320C. Each lane is also referred to as a single instruction multiple data (SIMD) lane. In various implementations, the hardware, such as circuitry, of each of vector processing circuits 310B-310D is an instantiation of the hardware of vector processing circuit 310A. Similarly, the hardware of lane 320C is an instantiation of the hardware of lane 320A. The components in lanes 320A-320C operate in lockstep. Although a particular number of vector processing circuits 310A-310D and lanes 320A-320C are shown, in other implementations, another number of these components are used based on design requirements.

In some implementations, the parallel computational lanes 320A-320C operate in lockstep. In various implementations, the data flow within each of the lanes 320A-320C is pipelined. Pipeline registers are used for storing intermediate results. Within a given row across lanes 320A-320C, vector arithmetic logic unit (ALU) 350 includes the same circuitry and functionality, and operates on the same instruction, but different data associated with a different thread. A particular combination of the same instruction and a particular data item of multiple data items is referred to as a “work item.” A work item is also referred to as a thread. The multiple work items (or multiple threads) are grouped into thread groups, where a “thread group” is a partition of work executed in an atomic manner.

In some implementations, a thread group includes instructions of a function call that operates on multiple data items concurrently. Each data item is processed independently of other data items, but the same sequence of operations of the subroutine is used. As used herein, a “thread group” is also referred to as a “work block” or a “wavefront.” Tasks performed by compute circuit 300 can be grouped into a “workgroup” that includes multiple thread groups (or multiple wavefronts). The hardware, such as circuitry, of a scheduler schedules a workgroup to a compute circuit, such as compute circuit 300, and divides the workgroup into separate thread groups (or separate wavefronts) and assigns the thread groups to the vector processing circuits 310A-310D.

In an implementation, lane 320A includes vector register file 330 for storing operand data for vector operations. In one implementation, the lanes 320A-320C also share the scalar register file 332 that stores operands for scalar operations. In some implementations, compute circuit 300 also includes scalar ALU 334 that performs operations with operands fetched from scalar register file 332. Lanes 320A-320C receive a scalar data value from one or more of the scalar register file 332 and scalar ALU 334. Scalar data values are common to each work item in a wavefront. In other words, a scalar data operand is used by each of the lanes 320A-320C at the same time. In contrast, a vector data operand is a unique per work item value, so each of the lanes 320A-320C do not work on the same copy of the vector data operand. In one implementation, one or more instructions use vector data operands and generate a scalar result. Therefore, although not shown, the result data from destination operand 370 is also routed to scalar register file 332 in some implementations.

Bypass circuit 340 includes selection circuitry, such as multiplexers, or mux gates, for routing result data from destination operand 370 to selection circuit 342 without retrieving operand data from vector register file 330 or scalar register file 332. Therefore, the vector ALU 350 can begin operations sooner. Selection circuit 342 also includes multiplexers and possible crossbar circuitry to route source operands to particular inputs of operations being performed by vector ALU 350. In various implementations, lane 320A is organized as a multi-stage pipeline. Intermediate sequential elements, such as staging flip-flop circuits, registers, or latches, are not shown for ease of illustration.

Vector ALU 350 can include a variety of execution circuits. In the illustrated implementation, vector ALU 350 includes a multiplier circuit 352 and an adder circuit 354. In various implementations, vector ALU 350 has the same functionality as vector ALU 150 (of FIG. 1) and each of the multiple vector ALUs 250 (of FIG. 2). Therefore, multiplier circuit 352 and adder circuit 354 have the same functionality as multiplier circuit 152 and adder circuit 154 (of FIG. 1). Although not shown, vector ALU 350 can include a variety of other types of execution circuits such as a comparator circuit, a norm functional circuit, a rounding functional circuit, a clamping circuit, a divider circuit, a square root function circuit, and so forth. Vector ALU 350 can also include circuitry that supports a variety of mathematical operations such as integer mathematical operations, Boolean bit-wise operations, and floating-point mathematical operations. Although a single staging sequential element is shown for destination operand 370, in other implementations, lane 320A uses multiple stages of sequential elements to route the result data to bypass circuit 340, scalar register file 332, and vector register file 330.

In various implementations, each of the vector processing circuits 310A-310D executes the single Wave Matrix Multiply Accumulate (WMMA) instruction that performs a multiplication and accumulate operation for entire matrices. As described earlier, the single WMMA instruction replaces multiple instructions being used to perform the multiplication and accumulate operation for entire matrices. As shown, each of the vector processing circuits 310A-310D uses data broadcasting and data forwarding via at least bypass circuit 340 and selection circuit 342, and supports execution operations with a variety of data formats multiple data formats such as the 32-bit floating-point data format, the 16-bit bfloat16 data format, the 8-bit fixed-point int8 integer data format, the 4-bit fixed-point int4 integer data format, one of a variety of types of directional blocked data formats, one of a variety of types of scalar data formats, and so forth. These data formats provide a variety of precisions. Each of the vector processing circuits 310A-310D supports data reuse without re-fetching from the vector register file 330 and the instruction decode operation of a single instruction (e.g., single WMMA instruction) to perform a multiplication and accumulate operation for the entire sizes of the matrices.

In one implementation, compute circuit 300 is used in a parallel data processing circuit such as a graphics processing unit (GPU), a digital signal processor (DSP), a field programmable gate array (FPGA), or otherwise. Parallel data processing circuits are efficient for data parallel computing found within loops of applications, such as in applications for computer and mobile device display graphics, molecular dynamics simulations, deep learning training, finance computations, and so forth. In some implementations, the functionality of compute circuit 300 is included as components on a single die, such as a single integrated circuit. In other implementations, the functionality of compute circuit 300 is included as multiple dies on a system-on-a-chip (SOC). In various implementations, compute circuit 300 is used in a desktop, a portable computer, a tablet computer, a smartwatch, a smartphone, or other.

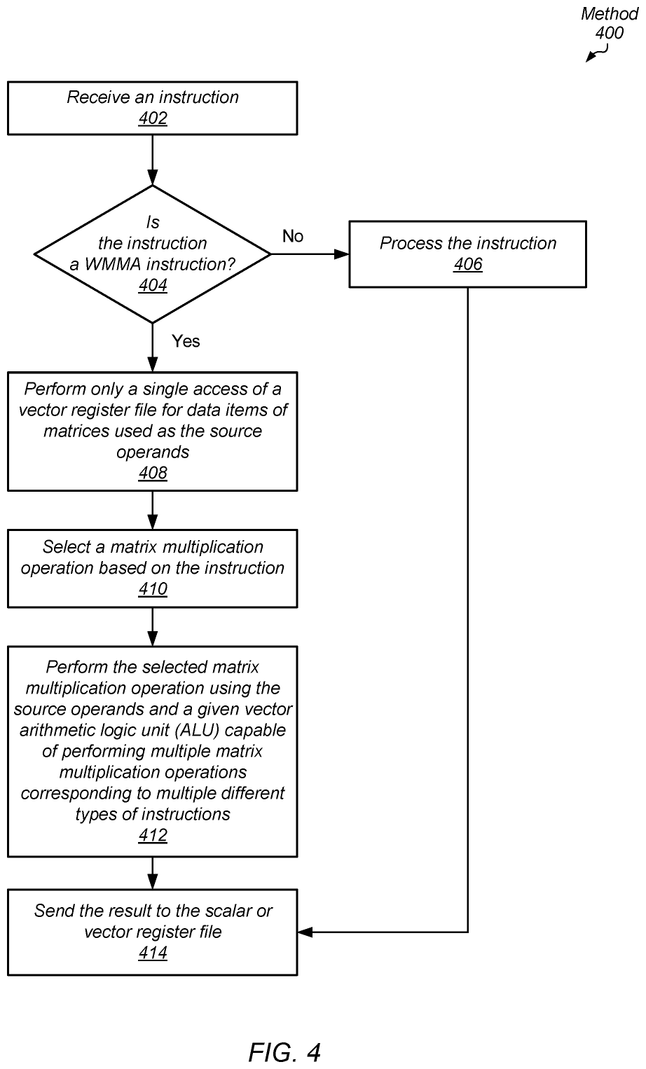

Referring to FIG. 4, a generalized diagram is shown of a method 400 for efficiently processing multiplication and accumulate operations for matrices in applications. For purposes of discussion, the steps in this implementation are shown in sequential order. However, in other implementations some steps occur in a different order than shown, some steps are performed concurrently, some steps are combined with other steps, and some steps are absent.

Circuitry receives an instruction (block 402). In some implementations, the circuitry is within a compute circuit of multiple compute circuits of a parallel data processing circuit with a highly parallel data microarchitecture. A general-purpose processing circuit translates instructions of an application to commands and stores the commands in a ring buffer. The parallel data processing circuit reads the commands from the ring buffer and assigns the commands to the multiple compute circuits. The commands can be treated as instructions with opcodes and operand identifiers. In various implementations, the parallel data processing circuit executes a variety of parallel data instructions such as a single Wave Matrix Multiply Accumulate (WMMA) instruction. The single WMMA instruction performs a multiplication and accumulate operation for matrices.

If the instruction is not the WMMA instruction (“no” branch of the conditional block 404), then the circuitry processes the instruction by executing operations indicated by the instruction. The multiple compute circuits perform the operations based at least upon the opcode of the instruction (block 406). For example, the circuitry sends one or more indications to the compute circuits specifying operations for the vector ALUs to perform. Afterward, the circuitry sends the result of the instruction to one of the scalar register file and the vector register file (block 414). If the instruction is the WMMA instruction (“yes” branch of the conditional block 404), then the circuitry performs only a single access of a vector register file for data items of matrices used as the source operands (block 408). Each of the multiple parallel lanes of execution of the compute circuits executes the instruction with each lane using respective data items. In other implementations, another type of processing circuit is used to execute the instructions and the register file is located elsewhere in the processing circuit.

The circuitry selects a matrix multiplication operation based on the instruction (block 410). In some implementations, the opcode of the instruction indicates the matrix multiplication operation is the FMA operation or the dot product operation. The circuitry performs the selected matrix multiplication operation using the source operands and a given vector arithmetic logic unit (ALU) capable of performing multiple matrix multiplication operations corresponding to multiple different types of instructions (block 412). In various implementations, each of the vector ALUs includes a multiplier circuit and an adder circuit. In various implementations, the multiplier circuit and the adder circuit are used to implement at least each of the fused multiply add (FMA) operation and the dot product (inner product) operation. Therefore, each of the vector ALUs does not include two independent, dedicated execution pipelines with one execution pipeline for the FMA operation and the other separate execution pipeline for the dot product operation. Rather, each of the vector ALUs includes a single execution pipeline for each of the FMA operation and the dot product operation. In various implementations, each of the vector ALUs includes multiple multiplier circuits, each having a size less than the size of data items read from the vector register file. Afterward, the circuitry sends the result of the instruction to one of the scalar register file and the vector register file (block 414).

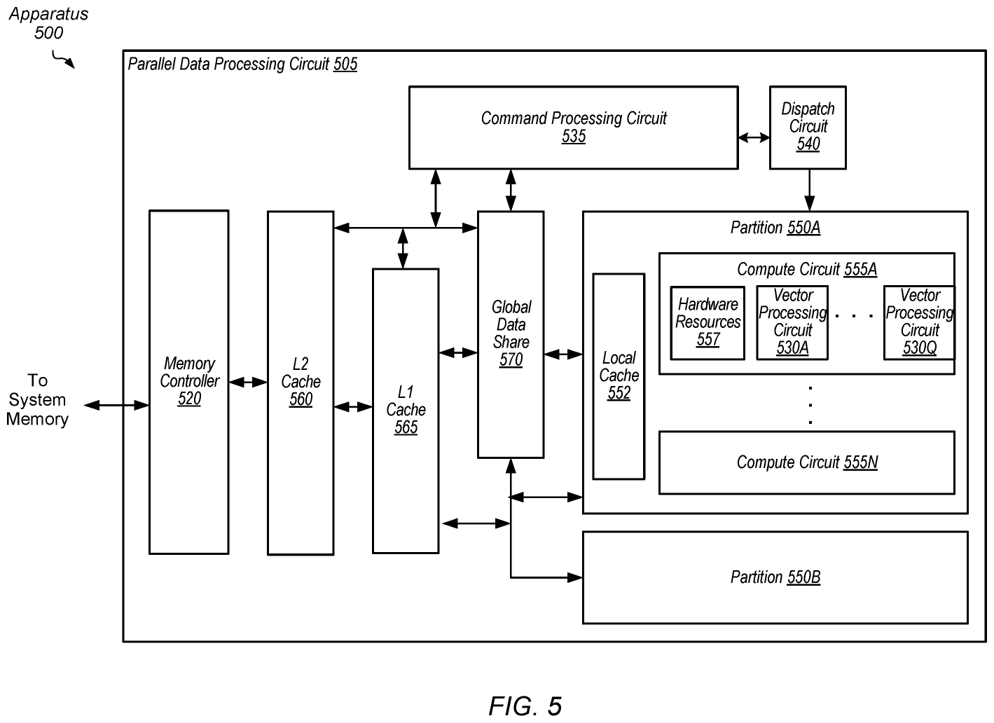

Turning now to FIG. 5, a block diagram is shown of an apparatus 500 that efficiently processes multiplication and accumulate operations for matrices in applications. In one implementation, apparatus 500 includes the parallel data processing circuit 505 with an interface to system memory. In an implementation, the parallel data processing circuit 505 is a graphics processing unit (GPU). In various implementations, apparatus 500 executes any of various types of highly parallel data applications. As part of executing an application, a host CPU (not shown) launches kernels to be executed by the parallel data processing circuit 505. The command processing circuit 535 receives kernels from the host CPU and determines when dispatch circuit 540 dispatches wavefronts of these kernels to the compute circuits 555A-555N.

Multiple processes of a highly parallel data application provide multiple kernels to be executed on the compute circuits 555A-555N. Each kernel corresponds to a function call of the highly parallel data application. The parallel data processing circuit 505 includes at least the command processing circuit (or command processor) 535, dispatch circuit 540, compute circuits 555A-555N, memory controller 520, global data share 570, shared level one (L1) cache 365, and level two (L2) cache 560. It should be understood that the components and connections shown for the parallel data processing circuit 505 are merely representative of one type processing circuit and does not preclude the use of other types of processing circuits for implementing the techniques presented herein. The apparatus 500 also includes other components which are not shown to avoid obscuring the figure. In other implementations, the parallel data processing circuit 505 includes other components, omits one or more of the illustrated components, has multiple instances of a component even if only one instance is shown in the apparatus 500, and/or is organized in other suitable manners. Also, each connection shown in the apparatus 500 is representative of any number of connections between components. Additionally, other connections can exist between components even if these connections are not explicitly shown in apparatus 500.

In an implementation, the memory controller 520 directly communicates with each of the partitions 550A-550B and includes circuitry for supporting communication protocols and queues for storing requests and responses. Threads within wavefronts executing on compute circuits 555A-555N read data from and write data to the cache 552, vector general-purpose registers, scalar general-purpose registers, and when present, the global data share 570, the shared L1 cache 565, and the L2 cache 560. When present, it is noted that the shared L1 cache 565 can include separate structures for data and instruction caches. It is also noted that global data share 570, shared L1 cache 565, L2 cache 560, memory controller 520, system memory, and local cache 552 can collectively be referred to herein as a “cache memory subsystem”.

In various implementations, the circuitry of partition 550B is a replicated instantiation of the circuitry of partition 550A. In some implementations, each of the partitions 550A-550B is a chiplet. As used herein, a “chiplet” is also referred to as an “intellectual property block” (or IP block). However, a “chiplet” is a semiconductor die (or die) fabricated separately from other dies, and then interconnected with these other dies in a single integrated circuit in the MCM. On a single silicon wafer, only multiple chiplets are fabricated as multiple instantiated copies of particular integrated circuitry, rather than fabricated with other functional blocks that do not use an instantiated copy of the particular integrated circuitry. For example, the chiplets are not fabricated on a silicon wafer with various other functional blocks and processors on a larger semiconductor die such as an SoC. A first silicon wafer (or first wafer) is fabricated with multiple instantiated copies of integrated circuitry a first chiplet, and this first wafer is diced using laser cutting techniques to separate the multiple copies of the first chiplet. A second silicon wafer (or second wafer) is fabricated with multiple instantiated copies of integrated circuitry of a second chiplet, and this second wafer is diced using laser cutting techniques to separate the multiple copies of the second chiplet.

In an implementation, the local cache 552 represents a last level shared cache structure such as a local level-two (L2) cache within partition 550A. Additionally, each of the multiple compute circuits 555A-555N includes vector processing circuits 530A-530Q, each with circuitry of multiple parallel computational lanes of simultaneous execution. These parallel computational lanes operate in lockstep. In various implementations, the data flow within each of the lanes is pipelined. Pipeline registers are used for storing intermediate results and circuitry for arithmetic logic units (ALUs) perform integer arithmetic, floating-point arithmetic, Boolean logic operations, branch condition comparisons and so forth. These components are not shown for ease of illustration.

Each of the ALUs within a given row across the lanes includes the same circuitry and functionality, and operates on the same instruction, but different data, such as a different data item, associated with a different thread. In various implementations, the vector ALUs of vector processing circuits 530A-530Q include circuitry that support executing a single Wave Matrix Multiply Accumulate (WMMA) instruction that performs a multiplication and accumulate operation for matrices. In various implementations, each of the vector ALUs of vector processing circuits 530A-530Q has the same functionality as vector ALU 150 (of FIG. 1), each of the multiple vector ALUs 250 (of FIG. 2), and vector ALU 350 (of FIG. 3). Therefore, each of compute circuits 555A-555N has the same functionality as compute circuit 300 (of FIG. 3).

In addition to the vector processing circuits 530A-530Q, the compute circuit 555A also includes the hardware resources 557. The hardware resources 557 include at least an assigned number of vector general-purpose registers (VGPRs) per thread, an assigned number of scalar general-purpose registers (SGPRs) per wavefront, and an assigned data storage space of a local data store per workgroup. Each of the compute circuits 555A-555N receives wavefronts from the dispatch circuit 540 and stores the received wavefronts in a corresponding local dispatch circuit (not shown). A local scheduler within the compute circuits 555A-555N schedules these wavefronts to be dispatched from the local dispatch circuits to the vector processing circuits 530A-530Q. The cache 552 can be a last level shared cache structure of the partition 550A.

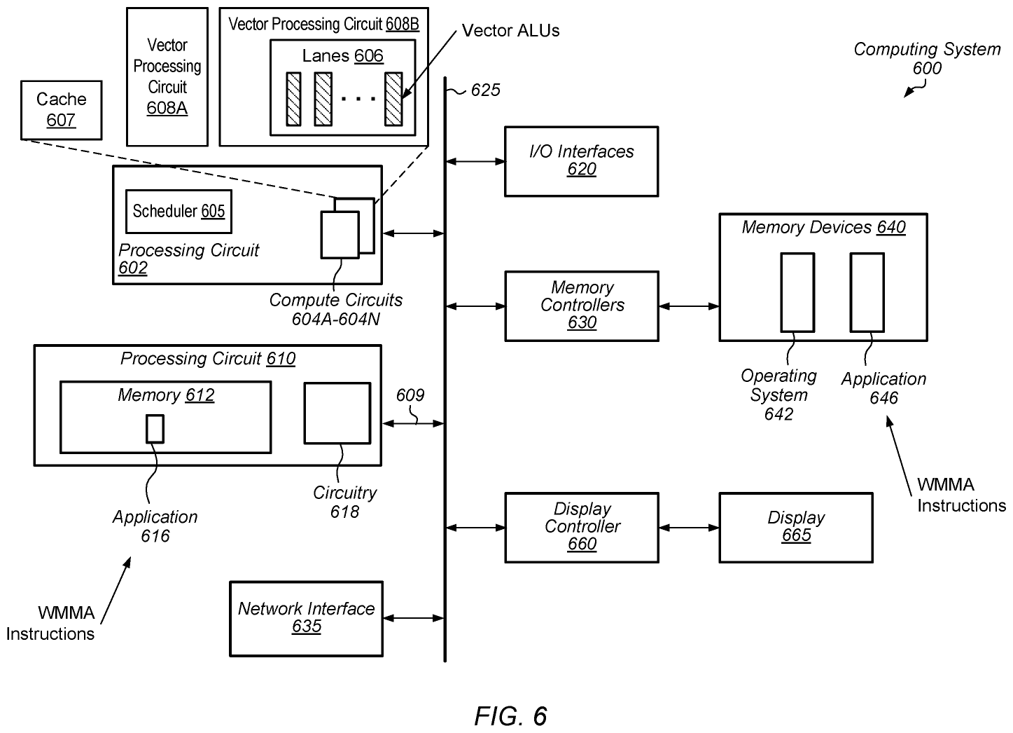

Turning now to FIG. 6, a generalized diagram is shown of a computing system 600 that efficiently processes multiplication and accumulate operations for matrices in applications. In an implementation, the computing system 600 includes at least processing circuits 602 and 610, input/output (I/O) interfaces 620, bus 625, network interface 635, memory controllers 630, memory devices 640, display controller 660, and display 665. In other implementations, computing system 600 includes other components and/or computing system 600 is arranged differently. For example, power management circuitry, and phased locked loops (PLLs) or other clock generating circuitry are not shown for ease of illustration. In various implementations, the components of the computing system 600 are on the same die such as a system-on-a-chip (SOC). In other implementations, the components are individual dies in a system-in-package (SiP) or a multi-chip module (MCM). A variety of computing devices use the computing system 600 such as a desktop computer, a laptop computer, a server computer, a tablet computer, a smartphone, a gaming device, a smartwatch, and so on.

Processing circuits 602 and 610 are representative of any number of processing circuits which are included in computing system 600. In an implementation, processing circuit 610 is a general-purpose central processing unit (CPU). In one implementation, processing circuit 602 is a parallel data processing circuit with a highly parallel data microarchitecture, such as a GPU. The processing circuit 602 can be a discrete device, such as a dedicated GPU (dGPU), or the processing circuit 602 can be integrated (an iGPU) in the same package as another processing circuit. Other parallel data processing circuits that can be included in computing system 600 include digital signal processing circuits (DSPs), field programmable gate arrays (FPGAs), application specific integrated circuits (ASICs), and so forth.

In various implementations, the processing circuit 602 includes multiple, replicated compute circuits 604A-604N, each including similar circuitry and components such as the vector processing circuits 608A-608B, the cache 607, and hardware resources (not shown). Vector processing circuit 608A includes replicated circuitry of the circuitry of the vector processing circuit 608A. Although two vector processing circuits are shown, in other implementations, another number of vector processing circuits is used based on design requirements. As shown, vector processing circuit 608B includes multiple, parallel computational lanes 606. In various implementations, each of the multiple, parallel computational lanes 606 has the functionality of lanes 320A-320C (of FIG. 3). Each of the multiple, parallel computational lanes 606 includes a vector ALU with the same functionality as vector ALU 150 (of FIG. 1), each of the multiple vector ALUs 250 (of FIG. 2), and vector ALU 350 (of FIG. 3). Therefore, each of compute circuits 604A-604N has the same functionality as compute circuit 300 (of FIG. 3) and compute circuits 555A-555N (of FIG. 5). Cache 607 can be used as a shared last-level cache in a compute circuit similar to local cache 552 (of FIG. 5).

The hardware of scheduler 605 assigns wavefronts to be dispatched to the compute circuits 604A-604N. In an implementation, scheduler 605 is a command processing circuit of a GPU. In some implementations, the application 446 stored on the memory devices 440 and its copy (application 616) stored on the memory 612 are a highly parallel data application that includes particular function calls using an API to allow the developer to insert a request in the highly parallel data application for launching wavefronts of a kernel (function call). In an implementation, this kernel launch request is a C++ object, and it is converted by circuitry 618 of the processing circuit 610 to a command. In addition, application 646 stored on memory devices 640 and its copy (application 616) stored on the memory 612 include WMMA instructions.

In some implementations, application 646 is a highly parallel data application that provides multiple kernels to be executed on the compute circuits 604A-604N. The high parallelism offered by the hardware of the compute circuits 604A-604N is used for real-time data processing. Examples of real-time data processing are rendering multiple pixels, image blending, pixel shading, vertex shading, and geometry shading. In such cases, each of the data items of a wavefront is a pixel of an image. Compute circuits 604A-604N can also be used to execute other threads that require operating simultaneously with a relatively high number of different data elements (or data items). Examples of these threads are threads for scientific, medical, finance and encryption/decryption computations.

Memory 612 represents a local hierarchical cache memory subsystem. Memory 612 stores source data, intermediate results data, results data, and copies of data and instructions stored in memory devices 640. Processing circuit 610 is coupled to bus 625 via interface 609. Processing circuit 610 receives, via interface 609, copies of various data and instructions, such as the operating system 642, one or more device drivers, one or more applications such as application 646, and/or other data and instructions. The processing circuit 610 retrieves a copy of the application 646 from the memory devices 640, and the processing circuit 610 stores this copy as application 616 in memory 612.

In some implementations, computing system 600 utilizes a communication fabric (“fabric”), rather than the bus 425, for transferring requests, responses, and messages between the processing circuits 602 and 610, the I/O interfaces 620, the memory controllers 630, the network interface 635, and the display controller 450. When messages include requests for obtaining targeted data, the circuitry of interfaces within the components of computing system 600 translates target addresses of requested data. In some implementations, the bus 425, or a fabric, includes circuitry for supporting communication, data transmission, network protocols, address formats, interface signals and synchronous/asynchronous clock domain usage for routing data.

Memory controllers 630 are representative of any number and type of memory controllers accessible by processing circuits 602 and 610. While memory controllers 630 are shown as being separate from processing circuits 602 and 610, it should be understood that this merely represents one possible implementation. In other implementations, one of memory controllers 630 is embedded within one or more of processing circuits 602 and 610 or it is located on the same semiconductor die as one or more of processing circuits 602 and 610. Memory controllers 630 are coupled to any number and type of memory devices 440.

Memory devices 440 are representative of any number and type of memory devices. For example, the type of memory in memory devices 440 includes Dynamic Random Access Memory (DRAM), Static Random Access Memory (SRAM), NAND Flash memory, NOR flash memory, Ferroelectric Random Access Memory (FeRAM), or otherwise. Memory devices 440 store at least instructions of an operating system 442, one or more device drivers, and application 446. In some implementations, application 446 is a highly parallel data application such as a video graphics application, a shader application, or other. Copies of these instructions can be stored in a memory or cache device local to processing circuit 610 and/or processing circuit 602.

I/O interfaces 620 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB). Various types of peripheral devices (not shown) are coupled to I/O interfaces 620. Such peripheral devices include (but are not limited to) displays, keyboards, mice, printers, scanners, joysticks or other types of game controllers, media recording devices, external storage devices, and so forth. Network interface 135 receives and sends network messages across a network.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. A processor comprising:
a vector register file;
a plurality of execution pipelines, each comprising a corresponding arithmetic logic circuit; and
circuitry, wherein responsive to an indication of a first instruction the circuitry is configured to:
fetch, from the vector register file only once, a first plurality of values; and
perform, using the corresponding arithmetic logic circuit of each of the plurality of execution pipelines, a first operation by sharing the first plurality of values between iterations of computations performed to perform the first operation.

2. The processor as recited in claim 1, wherein responsive to receiving an indication of a second instruction different from the first instruction, the circuitry is further configured to:
fetch, from the vector register file, a second plurality of values; and
perform, using the corresponding arithmetic logic circuit of the plurality of execution pipelines, a second operation different from the first operation by sharing the second plurality of values between iterations of computations performed to provide the second operation.

3. The processor as recited in claim 2, wherein the circuitry is further configured to fetch, from the vector register file, a first matrix as the first plurality of values and a second matrix as the second plurality of values.

4. The processor as recited in claim 3, wherein the first operation is a fused multiply add (FMA) operation and the second operation is a dot product operation.

5. The processor as recited in claim 4, wherein responsive to receiving the indication of the first instruction, the corresponding arithmetic logic circuit of each of the plurality of execution pipelines is configured to:
receive the values of the first matrix and the values of the second matrix; and
perform a matrix multiplication operation of a fused multiply add (FMA) operation using at least a first multiplier circuit and a second multiplier circuit, each having a size less than a size of the values of the first matrix and a size the values of the second matrix.

6. The processor as recited in in claim 5, wherein responsive to receiving the indication of the second instruction, the corresponding arithmetic logic circuit of each of the plurality of execution pipelines is configured to:
receive the values of the first matrix and the values of the second matrix; and
perform a matrix multiplication operation of a dot product operation using the first multiplier circuit and the second multiplier circuit.

7. The processor as recited in claim 3, wherein the circuitry is further configured to:
fetch the first matrix and the second matrix from the vector register file only once until each element of a resulting matrix is updated by one of the first operation and the second operation; and
store the first matrix and the second matrix in a plurality of storage elements for reuse by the plurality of execution pipelines.

8. A method, comprising:
responsive to receiving, by a vector processing circuit, an indication of a first instruction:
fetching, by the vector processing circuit from a vector register file, a first plurality of values; and
performing, using a corresponding arithmetic logic circuit of each of a plurality of execution pipelines of the vector processing circuit, a first operation by sharing the first plurality of values between iterations of computations performed to perform the first operation.

9. The method as recited in claim 8, responsive to receiving, by the vector processing circuit, an indication of a second instruction different from the first instruction:
fetching, by the vector processing circuit from the vector register file, a second plurality of values; and
performing, using the corresponding arithmetic logic circuit of each of the plurality of execution pipelines, a second operation different from the first operation by sharing the second plurality of values between iterations of computations performed to provide the second operation.

10. The method as recited in claim 9, further comprising fetching, from the vector register file by the vector processing circuit, a first matrix as the first plurality of values and a second matrix as the second plurality of values.

11. The method as recited in claim 10, wherein the first operation is a fused multiply add (FMA) operation and the second operation is a dot product operation.

12. The method as recited in claim 11, wherein responsive to receiving the indication of the first instruction, the method further comprises, by the corresponding arithmetic logic circuit of each of the plurality of execution pipelines:
receiving the values of the first matrix and the values of the second matrix; and
performing a matrix multiplication operation of a fused multiply add (FMA) operation using at least a first multiplier circuit and a second multiplier circuit, each having a size less than a size of the values of the first matrix and a size the values of the second matrix.

13. The method as recited in claim 12, wherein responsive to receiving the indication of the second instruction, the method further comprises, by the corresponding arithmetic logic circuit of each of the plurality of execution pipelines:
receiving the values of the first matrix and the values of the second matrix; and
performing a matrix multiplication operation of a dot product operation using the first multiplier circuit and the second multiplier circuit.

14. The method as recited in claim 10, further comprising:
fetching, by the vector processing circuit, the first matrix and the second matrix from the vector register file only once until each element of a resulting matrix is updated by one of the first operation and the second operation; and
storing, by the vector processing circuit, the first matrix and the second matrix in a plurality of storage elements for reuse by the plurality of execution pipelines.

15. A computing system comprising:
a memory; and
a processor comprising:
a vector register file;
a plurality of execution pipelines, each comprising a corresponding arithmetic logic circuit; and
circuitry configured to:
responsive to receiving an indication of a first instruction:
fetch, from the vector register file only once, a first plurality of values; and
perform, using the corresponding arithmetic logic circuit of each of the plurality of execution pipelines, a first operation by sharing the first plurality of values between iterations of computations performed to perform the first operation.

16. The computing system as recited in claim 15, wherein responsive to receiving an indication of a second instruction different from the first instruction, the circuitry is further configured to:
fetch, from the vector register file, a second plurality of values; and
perform, using the corresponding arithmetic logic circuit of the plurality of execution pipelines, a second operation different from the first operation by sharing the second plurality of values between iterations of computations performed to provide the second operation.

17. The computing system as recited in claim 16, wherein the circuitry is further configured to fetch, from the vector register file, a first matrix as the first plurality of values and a second matrix as the second plurality of values.

18. The computing system as recited in claim 17, wherein the first operation is a fused multiply add (FMA) operation and the second operation is a dot product operation.

19. The computing system as recited in claim 18, wherein responsive to receiving the indication of the first instruction, the corresponding arithmetic logic circuit of each of the plurality of execution pipelines is configured to:
receive the values of the first matrix and the values of the second matrix; and
perform a matrix multiplication operation of a fused multiply add (FMA) operation using at least a first multiplier circuit and a second multiplier circuit, each having a size less than a size of the values of the first matrix and a size the values of the second matrix.

20. The computing system as recited in claim 19, wherein responsive to receiving the indication of the second instruction, the corresponding arithmetic logic circuit of each of the plurality of execution pipelines is configured to:
receive the values of the first matrix and the values of the second matrix; and
perform a matrix multiplication operation of a dot product operation using the first multiplier circuit and the second multiplier circuit.
